(19) United States
(12) Patent Application Publication
(10) Pub. No.: US 2010/0266778 A1
(43) Pub. Date: Oct. 21, 2010

(54) Surface densifier composition for cementitious surfaces

(76) Inventor: Bo H. Gimvang, South Daytona, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/386,636

(22) Filed: Apr. 21, 2009

(51) Int. Cl. B05D 1/02; C09D 1/00; B05D 1/28

(52) U.S. Cl. 427/427; 106/286.7; 427/429; 427/428.01

(57) ABSTRACT

A liquid composition applicable to cementitious surfaces as a coating, penetrating liquid or sealant, and in particular applicable to concrete surfaces, consisting essentially of a mixture of lithium carbonate and lithium zirconate in water.

### BACKGROUND OF THE INVENTION

This invention relates generally to the field of coatings, sealants and penetrating solutions used to increase beneficial properties in cementitious surfaces, such as increasing hardness, shine, corrosion-resistance and the like.

Cementitious surfaces, such as for example concrete, are well known and are often used in situations where the surfaces are exposed to the elements. Rain, heat, cold, surface abrasion and the like can have damaging effects on the cementitious surfaces over time, and therefore coatings, sealants and penetrating liquids have been developed to address the damaging agents so as to prolong the useful life of the surfaces.

It is an object of this invention to provide a novel coating, the term coating being used herein to broadly encompass coatings, sealants and penetrating liquids for a cementitious surface, and in particular a concrete surface, that addresses the degradative effects of environmental substances by increasing the hardness, density, corrosion-resistance, and other desirable properties.

### SUMMARY OF THE INVENTION

The invention is a liquid composition applicable to cementitious surfaces, and in particular concrete surfaces, consisting essentially of a mixture of lithium carbonate and lithium zirconate in water, with the mixture of lithium carbonate and lithium zirconate present in a range of approximately 10 to 90 weight percent and the water present in a range of approximately 90 to 10 weight percent. The mixture of lithium carbonate and lithium zirconate may consist of lithium carbonate in a range of 10 to 90 weight percent and the lithium zirconate in a range of 90 to 10 weight percent. The liquid composition is applied to a cured cementitious surface by any suitable means, such as brushing, spraying, rolling, pouring or the like. The liquid composition increases the hardness, density, corrosion-resistance and shine properties of the cementitious surface to which it is applied:

### DETAILED DESCRIPTION OF THE INVENTION

The invention is a liquid composition applicable to cementitious surfaces as a coating, penetrating liquid or sealant, and in particular applicable to concrete surfaces, consisting essentially of a mixture of lithium carbonate and lithium zirconate in water, with the combination of lithium carbonate and lithium zirconate together present in a range of approximately 10 to 90 weight percent and the water present in a range of approximately 90 to 10 weight percent, with a most preferred ratio of approximately 40 weight percent water and 60 weight percent of the lithium carbonate and lithium zirconate combination. The mixture of lithium carbonate and lithium zirconate may consist of lithium carbonate present in a range of 10 to 90 weight percent and the lithium zirconate present in a range of 90 to 10 weight percent. The greater the percentage of lithium carbonate, the greater the hardness and density of the surface is improved. The greater the percentage of lithium zirconate, the greater the shine or polish of the surface is improved upon buffing.

The liquid composition is applied to a cured cementitious surface by any suitable means, such as brushing, spraying, rolling, pouring or the like. After suitable penetration and contact time, any excess composition is removed. The liquid composition increases the hardness, density, corrosion-resistance and shine properties of the cementitious surface to which it is applied.

It is understood that equivalents and substitutions for elements set forth above may be obvious to those of ordinary skill in the art, and therefore the true scope and definition of the invention is to be as set forth in the following claims.

I claim:

1. A liquid composition that increases the density, hardness, corrosion-resistance and shine of a cementitious surface upon application to said surface, said composition consisting essentially of a mixture of lithium carbonate, lithium zirconate and water.

2. The composition of claim 1, wherein the combination of said lithium carbonate and said lithium zircoante together present in said mixture in a range of 10 to 90 weight percent and said water is present in said mixture in a range of 90 to 10 weight percent.

3. The composition of claim 2, wherein the combination of said lithium carbonate and said lithium zircoante together present in said mixture is approximately 60 weight percent and said water present in said mixture is approximately 40 weight percent.

4. A liquid composition that increases the density, hardness, corrosion-resistance and shine of a cementitious surface upon application to said surface, said composition consisting of a mixture of lithium carbonate, lithium zirconate and water.

5. The composition of claim 4, wherein the combination of said lithium carbonate and said lithium zircoante together present in said mixture in a range of 10 to 90 weight percent and said water is present in said mixture in a range of 90 to 10 weight percent.

6. The composition of claim 5, wherein the combination of said lithium carbonate and said lithium zircoante together present in said mixture is approximately 60 weight percent and said water present in said mixture is approximately 40 weight percent.

7. A method of increasing the density of a cementitious surface comprising the steps of:
providing a liquid composition consisting essentially of a mixture of lithium carbonate, lithium zirconate and water;
applying said liquid composition to said cementitious surface.

8. The method of claim 7, wherein said liquid composition is applied by an application process chosen from the group of application processes consisting of brushing, spraying, rolling or pouring.

9. The method of claim 8, further comprising the step of mixing from 10 to 90 weight percent water with from 90 to 10 weight percent of the combination of lithium carbonate and lithium zirconate to form said liquid composition.

10. The method of claim 8, further comprising the step of mixing approximately 40 weight percent water with approximately 60 weight percent of the combination of lithium carbonate and lithium zirconate to form said liquid composition.
